(19) United States
(12) Patent Application Publication
(10) Pub. No.: US 2024/0258623 A1
(43) Pub. Date: Aug. 1, 2024

(54) BATTERY PACK FRAME ASSEMBLIES

(71) Applicant: Toyota Motor Engineering & Manufacturing North America, Inc., Plano, TX (US)

(72) Inventor: Weiling Wang, Livonia, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/103,925

(22) Filed: Jan. 31, 2023

(51) Int. Cl. H01M 50/242; H01M 50/291; H01M 50/293

(52) U.S. Cl. CPC H01M 50/242; H01M 50/291; H01M 50/293; H01M 2220/20

(57) ABSTRACT

A battery pack frame is disclosed. The battery pack frame includes a front cross member, a rear cross member, and a pair of side cross members extending between the front cross member and the rear cross member. Each of the pair of side cross members include a pair of sidewalls, a top wall, and a bottom wall defining a cavity. A reinforcing insert is disposed within the cavity, and includes a plurality of ridges and a plurality valleys.

### TECHNICAL FIELD

The present specification generally relates to battery pack frame assemblies and, more specifically, to battery pack frame assemblies having reinforcing inserts.

### BACKGROUND

Traditional vehicular battery pack frame assemblies may contain side frame structures that are used to transfer a side crash load evenly across internal cross members and protect battery modules during a crash event. In many cases, this side frame structure is made of extruded aluminum or cold rolled steel. However, this structure is often incapable of protecting the battery and distributing the crash load evenly during a crash event. Accordingly, a need exists for battery pack frame assemblies that are able to distribute a crash load evenly to meet safety targets for battery protection.

### SUMMARY

In one embodiment, a battery pack frame assembly is disclosed. The battery pack frame assembly includes a front cross member, a rear cross member, and a pair of side cross members extending between the front cross member and the rear cross member. Each of the pair of side cross members include a pair of sidewalls, atop wall, and a bottom wall defining a cavity. An insert is disposed within the cavity, and includes a plurality of ridges and a plurality of valleys.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of a battery pack frame, according to one or more embodiments described and illustrated herein;

FIG. 2A schematically depicts a partial cross-sectional view of an embodiment of the battery pack frame taken along line II-II of FIG. 1, according to one or more embodiments described and illustrated herein;

FIG. 2B schematically depicts a partial cross-sectional view of another embodiment of the battery pack frame taken along line II-II of FIG. 1, according to one or more embodiments described and illustrated herein;

FIG. 2C schematically depicts a partial cross-sectional view of another embodiment of the battery pack frame taken along line II-II of FIG. 1, according to one or more embodiments described and illustrated herein;

FIG. 3 schematically depicts a partial cross-sectional view of the battery pack frame taken along line III-III of FIG. 1, according to one or more embodiments described and illustrated herein;

FIG. 4 schematically depicts a partial cross-sectional view of another embodiment of the battery pack frame along line IV-IV of FIG. 1, according to one or more embodiments described and illustrated herein;

FIG. 5 schematically depicts a partial cross-sectional view of another embodiment of the battery pack frame of taken along line III-III of FIG. 1, according to one or more embodiments described and illustrated herein;

FIG. 6A schematically depicts a partial cross-sectional view of another embodiment of the battery pack frame of FIG. 2A, according to one or more embodiments shown and described herein;

FIG. 6B schematically depicts a partial cross-sectional view of another embodiment of the battery pack frame of FIG. 2B, according to one or more embodiments shown and described herein; and

FIG. 6C schematically depicts a partial cross-sectional view of another embodiment of the battery pack frame of FIG. 2C, according to one or more embodiments shown and described herein.

### DETAILED DESCRIPTION

Embodiments described herein are generally directed to vehicular battery pack frame assemblies having reinforcing inserts and foam material disposed within a cavity of the battery pack frame assembly. The reinforcing insert may provide additional rigidity to the battery pack frame of the vehicle, such that, in the event of a crash, the crash load is more evenly distributed between the insert and the battery pack frame. The foam material may be utilized to secure the insert within the cavity of the battery pack frame, and may further act to provide additional rigidity to the battery pack frame.

As will be described in additional detail herein, the battery pack frame assemblies include a front cross member, a rear cross member, and a pair of side cross members extending between the front cross member and the rear cross member. Each of the pair of side cross members include a pair of sidewalls, a top wall, and a bottom wall, with the pair of side walls, the top wall, and the bottom wall defining the cavity of the battery pack frame. The insert is disposed within the cavity, and includes a plurality of ridges and a plurality of valleys.

Various embodiments of battery pack frame assemblies are described in detail below. Whenever possible, the same reference numerals will be used throughout the drawings to refer to the same or like parts.

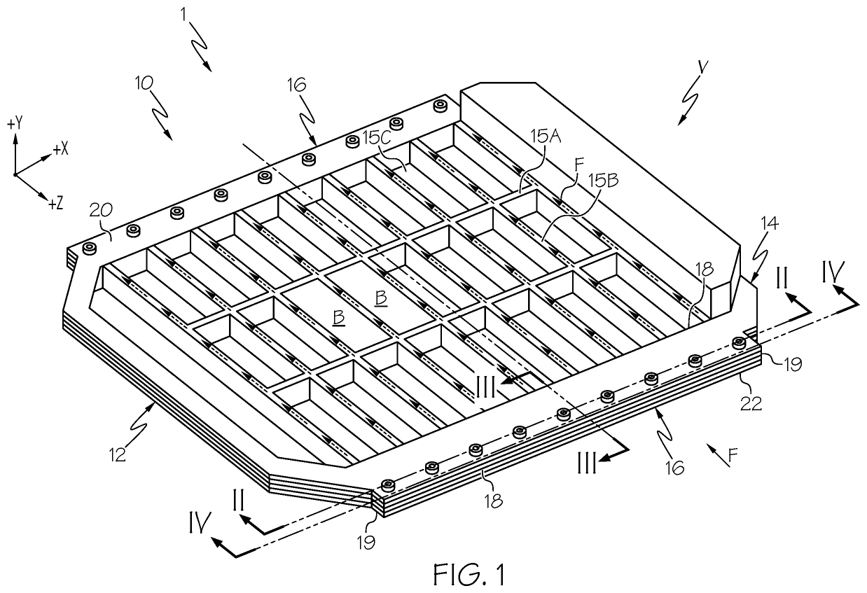

Referring now to FIG. 1, a vehicle V having a battery pack frame assembly 1 is illustrated. As illustrated in FIG. 1, the battery pack frame assembly 1 may include a battery pack frame 10 and a plurality of batteries B disposed within the battery pack frame 10. The battery pack frame 10 may include a front cross member 12, a rear cross member 14, and a pair of side cross members 16 that extend between ends of the front cross member 12 and the rear cross member 14. As depicted in FIG. 1, the front cross member 12 may be arranged downstream (e.g., in the −x-direction as depicted in the coordinate axis of FIG. 1) from the rear cross member 14, but it should be understood that the front cross member 12 and the rear cross member 14 may similarly be arranged in a reversed orientation (e.g, the rear cross member 14 being arranged downstream of the front cross member 12) without departing from the scope of the present disclosure. In these embodiments, the front cross member 12, the rear cross member 14, and the pair of side cross members 16 may be formed of aluminum, steel (e.g., cold rolled steel) or any similar material.

The battery pack frame 10 further includes a plurality of longitudinal intermediate cross members 15A and a plurality of traverse intermediate cross members 15B. The plurality of longitudinal intermediate cross members 15A extend between the front cross member 12 and the rear cross member 14. The plurality of traverse intermediate cross members 15B extend between the pair of side cross members 16. The plurality of longitudinal intermediate cross members 15A intersect with the plurality of traverse intermediate cross members 15B to form cavities 15C that receive the batteries B of the battery pack assembly 1.

In operation, the battery pack frame assembly 1 allow for a force F, such as a vehicular side crash load, to be transferred from an exterior side of one of the pair of side cross members 16 to the other of the pair of side cross members 16 via the plurality of traverse intermediate cross members 15B. For example, as depicted in FIG. 1, when the force F is applied to one of the side cross member 16, the force F may be transferred (e.g. in the −z-direction as depicted in the coordinate axis of FIG. 1) from the one side cross member 16 receiving the force F to the opposing side cross member 16 the plurality of traverse intermediate cross members 15B. By transferring the load L between the pair of side cross member 16, the load L may be more evenly distributed across the battery pack frame 10, and deformations within the battery pack frame 10 may be minimized such that the plurality of batteries B may remain secured within the battery pack frame 10.

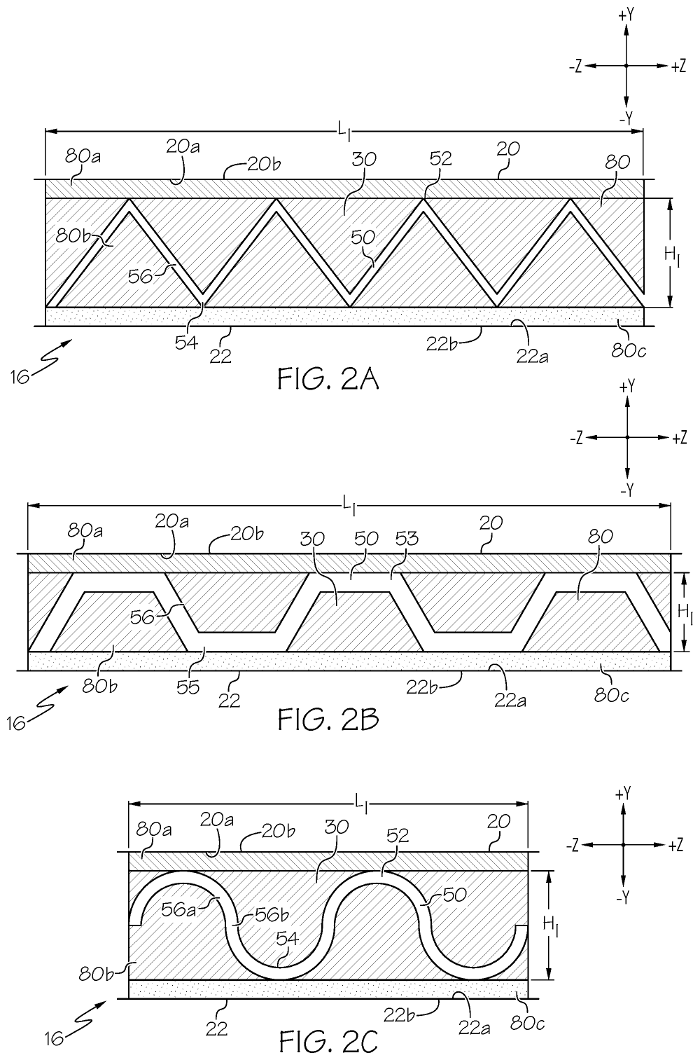

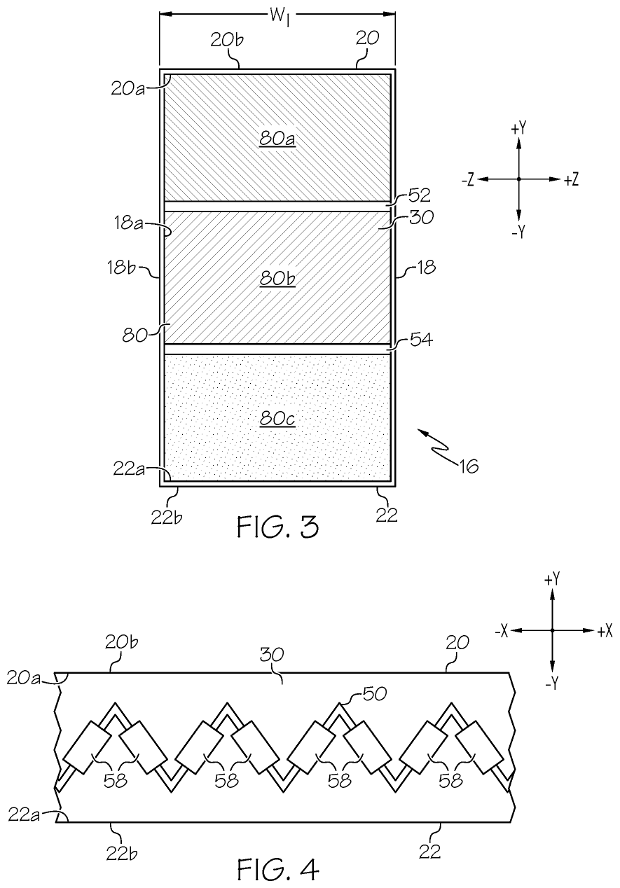

Referring now to FIGS. 1-3, the pair of side cross members 16 may further include a pair of sidewalls 18, a pair of end walls 19, a top wall 20, and a bottom wall 22. The pair of sidewalls 18 may include an interior surface 18a and an exterior surface 18b (FIG. 3). Similarly, the top wall 20 includes an interior surface 20a and an exterior surface 20b and the bottom wall 22 includes an interior surface 22a and an exterior surface 22b (FIGS. 2A-2C).

In these embodiments, the interior surface 20a of the top wall 20 and the interior surface 22a of the bottom wall 22 define a cavity 30. As depicted in FIGS. 2A-3, a reinforcing insert 50 and a foam material 80 may be inserted into the cavity 30, as will be described in additional detail herein.

Referring still to FIGS. 1-3, the reinforcing insert 50 may include an oscillating profile having a plurality of ridges 52 and a plurality of valleys 54. In these embodiments, the reinforcing insert 50 may include a width W_{I} that extends between the interior surface 18a of each of the pair of sidewalls 18 (e.g., in the +/−z-direction as depicted in the coordinate axis of FIG. 3), such that the reinforcing insert 50 contacts the interior surface 18a of each of the pair of sidewalls 18 when the reinforcing insert 50 is positioned within the cavity 30 of the battery pack frame 10.

The reinforcing insert 50 may further include a length L_{I} that extends between the pair of end walls 19 (e.g., in the +/−x-direction as depicted in the coordinate axes of FIGS. 1-3), such that the reinforcing insert 50 contacts each of the pair of end walls 19 when the reinforcing insert 50 is positioned in the cavity 30 of the battery pack frame 10. In these embodiments, the reinforcing insert 50 may also include a height H_{I}, which may be defined as the distance (e.g., in the +/−y-direction as depicted in the coordinate axis of FIGS. 2A-3) between the plurality of ridges 52 and the plurality of valleys 54 of the reinforcing insert 50. The height H_{I} of the reinforcing insert 50 may be any height, such that the reinforcing insert 50 may be positioned between the interior surface 20a of the top wall 20 and the interior surface 22a of the bottom wall 22 of the battery pack frame 10.

For example, in the embodiments depicted in FIGS. 2A-3, the reinforcing insert 50 may have a height H_{I} that is less than the distance between the interior surface 20a of the top wall 20 and the interior surface 22a of the bottom wall 22, such that the plurality of ridges 52 and the plurality of valleys 54 of the reinforcing insert 50 do not contact the interior surface 20a of the top wall 20 and the interior surface 22a of the bottom wall 22, respectively. However, in other embodiments, the reinforcing insert 50 may include a height H_{I} that is equal to the distance between the interior surface 20a of the top wall 20 and the interior surface 22a of the bottom wall 22, such that the plurality of ridges 52 and the plurality of valleys 54 of the reinforcing insert 50 contact the interior surface 20a of the top wall 20 and the interior surface 22a of the bottom wall 22, respectively, when the reinforcing insert 50 is positioned within the cavity 30.

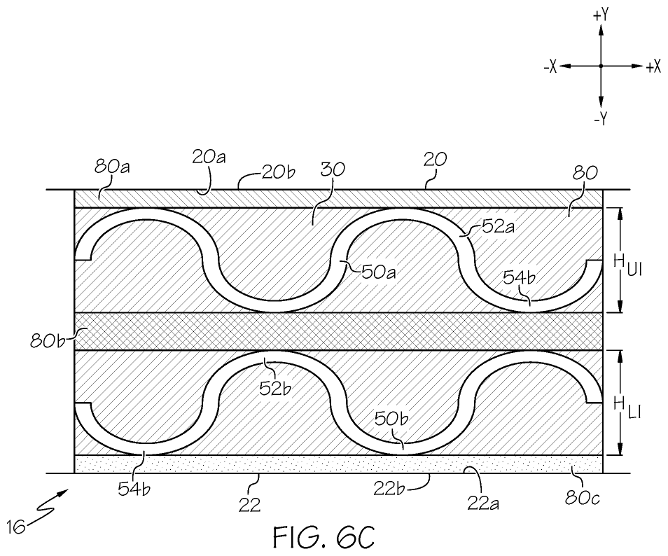

It should be further noted that, in some embodiments, the height H_{I} of the reinforcing insert 50 may be determined based on a number of reinforcing inserts 50 that are positioned within the cavity 30. For example, although FIGS. 2A-3 depict the cavity 30 as having a single reinforcing insert 50, in some embodiments, a plurality of reinforcing inserts 50 may be positioned within the cavity 30. It should be understood that, in embodiments in which a plurality of reinforcing inserts 50 are positioned within the cavity 30, each of the plurality of reinforcing inserts 50 may have a lesser height H_{I}, such that multiple reinforcing inserts 50 may be accommodated within the cavity 30. Embodiments of a battery pack frame 10 including a plurality of reinforcing inserts 50 will be described in additional detail herein with reference to FIGS. 6A-6C.

Referring now to FIGS. 2A-2C, it should be appreciated that the reinforcing insert 50 may include a variety of profiles that may be determined by the manner in which the reinforcing insert 50 oscillates between the plurality of ridges 52 and the plurality of valleys 54. In these embodiments, the reinforcing insert 50 may further include a plurality of extension members 56, that extend between each of the plurality of ridges 52 and the plurality of valleys 54 in order to provide the reinforcing insert 50 with a particular profile.

For example, as depicted in FIG. 2A, the reinforcing insert 50 may have a triangular-wave profile. In these embodiments, each of the plurality of ridges 52 and each of the plurality of valleys 54 may be offset at a predetermined angle, and the plurality of extension members 56 may extend between each of the plurality of ridges 52 and each of the plurality of valleys 54 at the predetermined angle, such that the reinforcing insert 50 includes the triangular-wave profile. Furthermore, the plurality of ridges 52 and the plurality of valleys 54 may be equally spaced (e.g., in the +/−x-direction as depicted in the coordinate axis of FIG. 2A) such that the profile of the reinforcing insert 50 is uniform along the length L_{I} of the reinforcing insert 50. Although the reinforcing insert 50 is depicted as having a uniform profile, it should be understood that, in some embodiments, the plurality of ridges 52 and plurality of valleys 54 may be spaced disproportionately across the length L_{I}, such that the reinforcing insert 50 does not have a uniform profile.

As depicted most clearly in FIG. 2B, the reinforcing insert 50 may further include a honeycomb profile. In these embodiments, the plurality of ridges 52 and the plurality of valleys 54 may include a plurality of upper surfaces 53 and a plurality of lower surfaces 55. The plurality of extension members 56 may extend between the plurality of upper surfaces 53 and the plurality of lower surfaces 55 at a predetermined angle. Because the plurality of ridges 52 and the plurality of valleys 54 are formed as upper surfaces 53 and lower surfaces 55, as opposed to singular points (e.g., as depicted in FIG. 2A), extending the extension members 56 between the upper surfaces 53 and the lower surfaces 55 of the reinforcing insert 50 may allow the reinforcing insert 50 to achieve the depicted honeycomb profile.

Turning now to FIG. 2C, the reinforcing insert 50 may further include a semi-circular profile. In these embodiments, the plurality of extension members 56 may be curved. For example, each of the plurality of extension members 56 may include a concave portion 56a and a convex portion 56b, such that the reinforcing insert 50 oscillates between each of the plurality of ridges 52 and each of the plurality of valleys 54 in a semi-circular profile.

It should be understood that the reinforcing insert 50 depicted in FIGS. 2A-2C are exemplary in nature, and the reinforcing insert 50 may include any profile without departing from the scope of the present disclosure. For example, the reinforcing insert 50 may include a sine-wave profile, a rectangular profile, an octagonal profile, or any other similarly shaped profile without departing from the scope of the present disclosure.

Referring again to FIGS. 1-3, the battery pack frame 10 may further include a foam material 80, which may be inserted into vacant space within the cavity 30 that is unoccupied by the reinforcing insert 50. For example, in these embodiments, the foam material 80 may be inserted into the cavity 30 such that the foam material 80 surrounds the reinforcing insert 50 and at least partially fills the cavity 30. As depicted in FIGS. 1-3, the foam material 80 may be inserted into the cavity 30 such that the foam material 80 extends in a longitudinal direction (e.g., in the +/−x direction as depicted in the coordinate axes of FIGS. 1-3) between the end walls 19 of the side cross member 16 and in a lateral direction (e.g., in the +/−y-direction as depicted in the coordinate axes of FIGS. 1-3) between the interior surface 20a of the top wall 20 and the interior surface 22a of the bottom wall 22. In these embodiments, the foam material 80 may further extend between the interior surface 18a of each of the pair of sidewalls 18 (e.g., in the +/−z-direction as depicted in the coordinate axis of FIG. 3), such that, when the foam material 80 is inserted in the cavity 30, the foam material 80 contacts the interior surfaces 18a, 20a, 22a of the sidewalls 18, the top wall 20, and the bottom wall 22. As the foam material 80 fills the cavity 30, the foam material 80 may further fill the space between the plurality of ridges 52 and the plurality of valleys 54 of the reinforcing insert 50.

In the embodiments described herein, a variety of foam material 80 may be utilized within the cavity 30. In these embodiments, the foam material 80 utilized within the cavity 30 may be determined based on a load distributed across the battery pack frame 10. For example, the density of the foam material 80 utilized within the cavity 30 may be proportional to the load distributed across the battery pack frame 10. In these embodiments, a battery pack frame 10 subjected to a greater load may require a higher density foam material 80 within the cavity 30 in order to effectively distribute the load exerted on the battery pack frame 10.

For example, the foam material 80 may include a high energy absorption foam, such as a polyurethane foam. In these embodiments, the foam material 80 may have a density between 0.1-1.0 g/cm³, such as between 0.1-0.7 g/cm3. In other embodiments, the foam material 80 may include a structural foam, such as a polyamide particle foam. In these embodiments, the foam material 80 may have a density between 250-400 g/L, such as between 290-350 g/L.

Referring now to FIGS. 2A-3, it should be noted that, in some embodiments, the foam material 80 may include a plurality of foam materials 80. In these embodiments, each of the plurality of foam materials 80 may include a different material composition and/or different densities. For example, the plurality of foam materials 80 may include a first foam material 80a, a second foam material 80b, and a third foam material 80c. In these embodiments, the first foam material 80a, second foam material 80b, and third foam material 80c may each include the same material composition (e.g., polyamide, polyurethane, etc.), but may have differing densities. For example, the first foam material 80a may be a polyamide foam having a density of 290 g/L, the second foam material 80b may be a polyamide foam having a density of 320 g/L, and the third foam material 80c may be a polyamide foam having a density of 350 g/L. In these embodiments, the third foam material 80c (e.g, the foam having the highest density) may be positioned within the cavity 30 where the heaviest load is experienced.

Similarly, the first foam material 80a, second foam material 80b, and third foam material 80c may include different material compositions. For example, the first foam material 80a and the third foam material 80c may be a polyurethane foam, while the second foam material 80b may be a polyamide foam. As has been described herein, the plurality of foams 80 may be positioned within the cavity 30 based on the load distribution across the battery pack frame 10. It should be understood that the embodiments described herein are intended to be exemplary in nature, and the plurality of foams 80 may include any material of any density without departing from the scope of the present disclosure.

In embodiments in which the plurality of foam materials 80 are utilized, the plurality of foam materials 80 may be positioned within the cavity 30 relative to the reinforcing insert 50. For example, as depicted in FIGS. 2A-3, the plurality of foam materials 80 may include the first foam material 80a, the second foam material 80b, and the third foam material 80c. In these embodiments, the first foam material 80a may be positioned above the plurality of ridges 52 of the reinforcing insert 50 (e.g., between the plurality of ridges 52 and the interior surface 20a of the top wall 20), the second foam material 80b may be positioned within the space between each of the plurality of ridges 52 and the plurality of valleys 54, and the third foam material 80c may be positioned below the plurality of valleys 54 (e.g., between the plurality of valleys 54 and the interior surface 22a of the bottom wall 22).

In the embodiments described herein, the foam material 80 may be utilized to secure the reinforcing insert 50 within the cavity 30. Furthermore, the foam material 80 may act to supply additional rigidity to the cavity 30, which may in turn increase the load that the battery pack frame 10 is able to withstand without buckling or undergoing similar deformation.

Referring still to FIGS. 2A-3, in some embodiments, the foam material 80 may be inserted into the cavity 30 after the reinforcing insert 50 is positioned within the cavity 30. In these embodiments, the reinforcing insert 50 is inserted into the cavity 30 of the battery pack frame 10, and is positioned using temporary markers (e.g., plastic tabs, etc.). Once the reinforcing insert 50 is positioned, the foam material 80 is inserted into the cavity 30 such that the foam material 80 fills the cavity 30 and secures the reinforcing insert 50 within the cavity 30.

In other embodiments, the foam material 80 and the reinforcing insert 50 may be formed together prior to inserting the foam material 80 and the reinforcing insert 50 within the cavity 30. For example, in these embodiments, the foam material 80 may be formed (e.g., via steam molding or another similar process) around the reinforcing insert 50, such that the foam material 80 and the reinforcing insert 50 together have a volume sufficient to fill the volume of the cavity 30. Once the foam material 80 is formed around the reinforcing insert 50, the reinforcing insert 50 and the foam material 80 may be inserted together into the cavity 30.

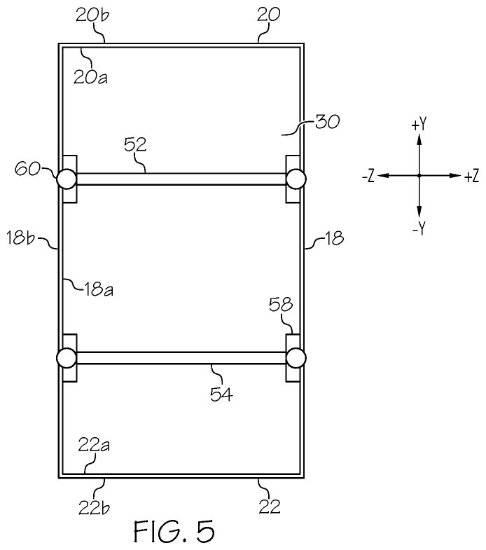

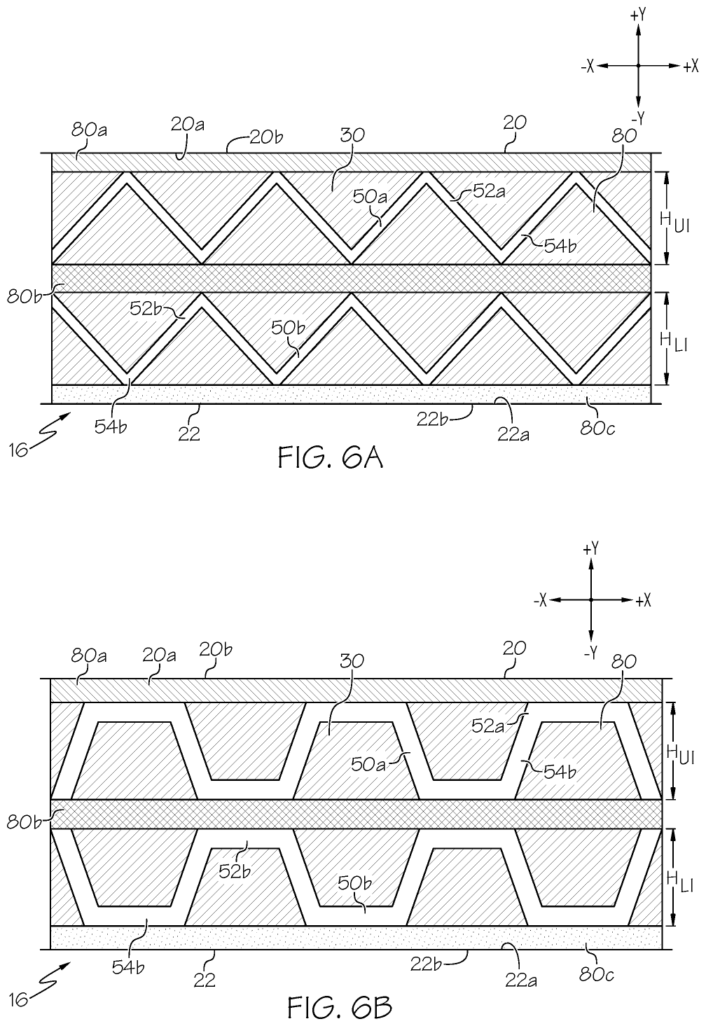

Turning now to FIGS. 4 and 5, in some embodiments, the reinforcing insert 50 may be secured within the cavity 30 without the use of the foam material 80. In these embodiments, the reinforcing insert 50 may further include a plurality of flanges 58 positioned along each of the plurality of extension members 56 that extend between the plurality of ridges 52 and the plurality of valleys 54. As depicted most clearly in FIG. 5, a weld 60 may be formed between each of the plurality of flanges 58 and the interior surface 18a of each of the sidewalls 18, respectively, such that the reinforcing insert 50 is secured within the cavity 30. In these embodiments, the weld 60 may be formed between the plurality of flanges 58 and the interior surface 18a of each of the sidewalls 18, respectively, using laser welding or any other similar welding process.

Turning now to FIGS. 6A-6C, embodiments of a battery pack frame 10 having a plurality of reinforcing inserts 50 are depicted. In these embodiments, the plurality of reinforcing inserts 50 may include an upper reinforcing insert 50a and a lower reinforcing insert 50b, with the upper reinforcing insert 50a being positioned above (e.g., in the +y direction as depicted in the coordinate axis of FIGS. 6A-6C) the lower reinforcing insert 50b.

In these embodiments, the upper reinforcing insert 50a and the lower reinforcing insert 50b may both have a length that extends between the end walls 19, and a width that extends between the interior surfaces 18a of the sidewalls 18, as has been described herein in reference to FIGS. 1-3. However, the upper reinforcing insert 50a and the lower reinforcing insert 50b may each have a height H_{UI}, H_{LI} that, when combined, is less than the distance (e.g., in the +/−y-direction as depicted in the coordinate axes of FIGS. 6A-6C) between the interior surface 20a of the top wall 20 and the interior surface 22a of the bottom wall 22, such that both the upper reinforcing insert 50a and the lower reinforcing insert 50b may be secured within the cavity 30.

For example, in the embodiments depicted in FIGS. 6A-6C, the upper reinforcing insert 50a and the lower reinforcing insert 50b may each have heights H_{UI}, H_{LI} that are less than half the distance between the interior surface 20a of the top wall 20 and the interior surface 22a of the bottom wall 22. Furthermore, the height H_{UI} of the upper reinforcing insert 50a and the height H_{LI} of the lower reinforcing insert 50b may be equal, such that the upper reinforcing insert 50a and the lower reinforcing insert 50b may be equally spaced within the cavity 30.

Although the upper reinforcing insert 50a and lower reinforcing insert 50b are depicted as having equal heights, it should be appreciated that, in some embodiments, the upper reinforcing insert 50a and the lower reinforcing insert 50b may have different heights. It should be understood that the upper reinforcing insert 50a and the lower reinforcing insert 50b may have any height, so long as the combined height of the upper reinforcing insert 50a and the lower reinforcing insert 50b is less than the distance between the interior surface 20a of the top wall 20 and the interior surface 22a of the bottom wall 22, such that both the upper reinforcing insert 50a and the lower reinforcing insert 50b may be secured within the cavity 30.

Furthermore, it should be appreciated that the plurality of reinforcing inserts 50 are not limited to an upper reinforcing insert 50a and a lower reinforcing insert 50b. For example, in some embodiments, the plurality of reinforcing inserts 50 may include a first insert, a second insert, and a third insert. It should be understood that the battery pack frame 10 may include any number of reinforcing inserts 50, so long as the combined height of each of the plurality of reinforcing inserts 50 is less than the distance between the interior surface 20a of the top wall 20 and the interior surface 22a of the bottom wall 22, such that each of the plurality of reinforcing inserts 50 may be secured within the cavity 30.

Referring still to FIGS. 6A-6C, the upper reinforcing insert 50a and lower reinforcing insert 50b may be positioned within the cavity 30 such that the upper reinforcing insert 50a and lower reinforcing insert 50b have a mirrored-orientation (e.g., flipped about the x-axis, as depicted in the coordinate axes of FIGS. 6A-6C). For example, in these embodiments, the plurality of valleys 54a of the upper reinforcing insert 50a may be positioned proximal to plurality of ridges 52b of the lower reinforcing insert 50b. Similarly, the plurality of ridges 52a of the upper reinforcing insert 50a may be positioned proximal to, or in contact with, the interior surface 20a of the top wall 20 of the cavity 30, while the plurality of valleys 54b of the lower reinforcing insert 50b may be positioned proximal to, or in contact with, the interior surface 22a of the bottom wall 22 of the cavity 30. Although the upper reinforcing insert 50a and the lower reinforcing insert 50b depicted in FIGS. 6A-6C may be positioned within the cavity 30 in a mirrored-orientation, the reinforcing inserts 50 may be positioned within the cavity 30 with any orientation without departing from the scope of the present disclosure.

It should be further noted that each of the plurality of reinforcing inserts 50 may take any shape without departing from the scope of the present disclosure. Although FIGS. 6A-6C depict both the upper reinforcing insert 50a and lower reinforcing insert 50b as having the same profile (e.g., triangular, honeycomb, and semi-circular, respectively) the upper reinforcing insert 50a and lower reinforcing insert 50b may have different profiles. For example, the upper reinforcing insert 50a may include a triangular-wave profile, while the lower reinforcing insert 50b may include a semi-circular profile. Accordingly, it should be understood that the battery pack frames 10 depicted in FIGS. 6A-6C are exemplary in nature.

Referring still to FIGS. 6A-6C, in embodiments in which the battery pack frame 10 includes the plurality of reinforcing inserts 50, foam material 80 may be disposed within the cavity 30 in the vacant space unoccupied by the plurality of reinforcing inserts 50. In some embodiments, a single foam material 80 may be disposed within the cavity 30 to secure the plurality of reinforcing inserts 50 within the cavity 30, as has been described herein. In other embodiments, a plurality of foam materials 80 may be needed in order to secure the plurality of reinforcing inserts 50 within the cavity 30 and support a particular load.

In embodiments in which the foam material 80 includes a plurality of foam materials 80, the plurality of foam materials 80 may be positioned within the cavity 30 relative to the plurality of reinforcing inserts 50. For example, in the embodiments depicted in FIGS. 6A-6C, the plurality of foam materials 80 may include the first foam material 80a, the second foam material 80b, and the third foam material 80c.

As depicted in FIGS. 6A-6C, the first foam material 80a may be disposed above the upper reinforcing insert 50a, such that the first foam material 80a is positioned between the plurality of ridges 52a of the upper reinforcing insert 50a and the interior surface 20a of the top wall 20. The second foam material 80b may be disposed between the upper reinforcing insert 50a and the lower reinforcing insert 50b, such that the second foam material 80b is positioned between the plurality of valleys 54a of the upper reinforcing insert 50a and the plurality of ridges 52b of the lower reinforcing insert 50b. Similarly, the third foam material 80c may be positioned below the lower reinforcing insert 50b, such that the third foam material 80c is positioned between the plurality of valleys 54b of the lower reinforcing insert 50b and the interior surface 22a of the bottom wall 22. As has been described herein, the plurality of foam materials 80 may include varying material compositions and/or densities as facilitated by the load distributed across the battery pack frame 10.

Although FIGS. 6A-6C depict the plurality of reinforcing inserts 50 as being secured within the cavity 30 with foam material 80, it should be understood that, in some embodiments, the plurality of inserts may be secured via alternate means. For example, each of the plurality of reinforcing inserts 50 may include a plurality of flanges 58 disposed on the extension members 56. In these embodiments, the plurality of flanges 58 may be welded to the interior surfaces 18a of each of the sidewalls 18, respectively, to secure the plurality of reinforcing inserts 50 within the cavity 30 (as described with reference to FIGS. 4-5).

It should now be understood that embodiments of the present disclosure are directed to battery pack frames including an insert and a foam material secured within a cavity of the battery pack frame. The insert and foam material act to increase the rigidity of the battery pack frame, such that the battery pack frame is capable of withstanding loads caused by vehicle crashes without buckling or undergoing similar deformation. The insert and the foam material are positioned within the cavity of the battery pack frame based on the load distribution across the battery pack frame.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

What is claimed:

1. A battery pack frame comprising:
a front cross member;
a rear cross member;
a pair of side cross members extending between the front cross member and the rear cross member, each of the pair of side cross members including a pair of sidewalls, a top wall, and a bottom wall defining a cavity; and
a reinforcing insert disposed within the cavity, the insert having a plurality of ridges and a plurality of valleys.

2. The battery pack frame of claim 1, further comprising a foam material disposed above or below the insert.

3. The battery pack frame of claim 1, wherein the reinforcing insert has a triangular-wave profile.

4. The battery pack frame of claim 1, wherein the plurality of ridges and the plurality of valleys of the reinforcing insert form a honeycomb profile.

5. The battery pack frame of claim 1, wherein the plurality of ridges and the plurality of valleys of the reinforcing insert form a semi-circular profile.

6. The battery pack frame of claim 2, wherein the foam material is a polyurethane foam having a density between 0.1-0.7 g/cm3.

7. The battery pack frame of claim 2, wherein the foam i material s a polyamide foam having a density between 290-350 g/L.

8. The battery pack frame of claim 2, wherein the foam material comprises a plurality of foam materials including a first foam material, a second foam material, and a third foam material.

9. The battery pack frame of claim 8, wherein the reinforcing insert comprises a plurality of reinforcing inserts including an upper reinforcing insert and a lower reinforcing insert.

10. The battery pack frame of claim 9, wherein the first foam material is disposed above the upper reinforcing insert, the second foam material is disposed between the upper reinforcing insert and the lower reinforcing insert, and the third foam material is disposed below the lower reinforcing insert.

11. The battery pack frame of claim 8, wherein the first foam material is disposed between the plurality of ridges of the reinforcing insert and the top wall of the pair of sidewalls, the second foam material is disposed between each of the plurality of ridges and the plurality of valleys of the reinforcing insert, and the third foam material is disposed between the plurality of valleys of the reinforcing insert and the bottom wall of the pair of sidewalls.
